(19) United States
(12) Patent Application Publication
(10) Pub. No.: US 2017/0187664 A1
(43) Pub. Date: Jun. 29, 2017

(54) SELECTIVELY PROVIDING ACCESS TO DIGITAL CONTENT IN SOCIAL NETWORKING SERVICES

(71) Applicant: Google Inc., (US)

(72) Inventors: Jean-Christophe E. Lilot, Mountain View, CA (US); Jonathan Terleski, Mountain View, CA (US); Joseph R. Smarr, Half Moon Bay, CA (US); Shimrit Ben-Yair, Sunnyvale, CA (US); Bryant Fong, Kirkland, WA (US); Eric W. Barndollar, Mountain View, CA (US)

(73) Assignee: Google Inc., Mountain View, CA (US)

(21) Appl. No.: 13/740,133

(22) Filed: Jan. 11, 2013

Related U.S. Application Data
(60) Provisional application No. 61/586,580, filed on Jan. 13, 2012.

(51) Int. Cl. G06Q 30/02; H04L 29/06

(52) U.S. Cl. CPC H04L 51/32

(57) ABSTRACT

Implementations of the present disclosure include actions of defining a first group of contacts, the first group of contacts being defined based on input provided by a user of a social networking service and including other users of the social networking service, receiving a first selection of a first attribute associated with the first group of contacts, the first attribute providing that at least some digital content distributed by contacts is accessible to the user, and non-public digital content associated with the user that is inaccessible to at least one of the contacts, defining a distribution group associated with an item that is to be distributed, the distribution group including a plurality of groups of contacts, determining that the first group is included in the distribution group, and distributing the item to contacts in the distribution group except for contacts also in the first group.

### CROSS-REFERENCE TO RELATED APPLICATIONS

This application claims the benefit and priority of U.S. Provisional Application No. 61/586,580, filed Jan. 13, 2012, the disclosure of which is expressly incorporated herein by reference in the entirety.

### BACKGROUND

Internet-based social networking services provide a digital medium for users of the Internet to interact with one another and share information. For examples, users are able to distribute digital content (e.g., textual comments, digital images, digital videos, digital audio, hyperlinks to websites, etc.) to other users that they might be connected with in the social networking service. Digital content that is distributed to a user can be displayed to the user in a stream page provided by the social networking service.

### SUMMARY

This specification generally relates to computer software systems and methods, in particular, to systems and methods for selectively providing access to digital content within social networking services.

In general, innovative aspects of the subject matter described in this disclosure may be embodied in methods that include the actions of defining a first group of one or more contacts, the first group of one or more contacts being defined based on input provided by a user of a social networking service and including one or more other users of the social networking service, and receiving a first selection of a first attribute associated with the first group of one or more contacts, the first attribute providing that at least some digital content distributed by any of the one or more contacts is accessible to the user, and non-public digital content associated with the user is inaccessible to at least one of the one or more contacts. Other implementations of this aspect include corresponding systems, apparatus, and computer programs, configured to perform the actions of the methods, encoded on computer storage devices.

These and other implementations may each optionally include one or more of the following features. For instance, the at least some digital content distributed by any of the one or more contacts includes public digital content; receiving a second selection of a second attribute associated with the first group of one or more contacts, the second attribute providing an analytical constraint to digital content distributed by the user; the second attribute provides a data size constraint; the second attribute provides a frequency constraint; actions further include providing an asymmetrical relationship between the user and each of the one or more contacts; actions further include providing a symmetrical relationship between the user and at least one of the one or more contacts; actions further include selectively providing access to the non-public digital content associated with the user; actions further include providing access to the non-public digital content associated with the user to contacts networked with the user within the social networking service and excluding the first group of one or more contacts; actions further include applying a least restrictive distribution preference to a particular contact of the first group of one or more contacts, such that the non-public digital content associated with the user is accessible to the particular contact; actions further include providing access to the non-public digital content associated with the user to contacts networked with the user within the social networking service, the contacts including the first group of one or more contacts; and actions further include applying a most restrictive distribution preference to a particular contact of the first group of one or more contacts, such that the non-public digital content associated with the user is inaccessible to the particular contact.

In general, innovative aspects of the subject matter described in this disclosure may be embodied in methods that include the actions of defining a first group of one or more contacts, the first group of one or more contacts being defined based on input provided by a user of a social networking service and including one or more other users of the social networking service, receiving a first selection of a first attribute associated with the first group of one or more contacts, the first attribute providing that at least some digital content distributed by any of the one or more contacts is accessible to the user, and non-public digital content associated with the user is inaccessible to at least one of the one or more contacts, defining a distribution group associated with an item that is to be distributed using the social networking service, the distribution group including a plurality of groups of one or more contacts, determining that the first group is included in the distribution group, and distributing the item to each contact in the plurality of groups except for contacts in the first group. Other implementations of this aspect include corresponding systems, apparatus, and computer programs, configured to perform the actions of the methods, encoded on computer storage devices.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a diagram of an example network architecture.

FIG. 2 is a diagram of an example social network including social circles.

FIG. 3 depicts an example graphical user interface for creating and maintaining social circles.

FIGS. 4A-4B depict an example stream page for a user of a social networking service including an example content sharing interface.

FIG. 5 depicts an example interface for defining one or more attributes associated with a particular social circle.

FIG. 6 is a flowchart of an example process that can be executed in implementations of the present disclosure.

FIG. 7 is a flowchart of an example process that can be executed in implementations of the present disclosure.

Like reference numbers represent corresponding parts throughout.

### DETAILED DESCRIPTION

In general, implementations of the present disclosure are directed to selectively providing access to digital content within social networking services. In some implementations, a user of the social networking service and a contact who uses the social networking service and with whom the user is networked via the social networking service can share digital content with one another via the social networking service. In some examples, a relationship between the user and the contact can be provided as a symmetrical relationship. In some examples, a symmetrical relationship enables non-public digital content associated with the user to be accessible to the contact, and conversely, non-public digital contented associated with the contact to be accessible to the user. In some examples, the relationship between the user and the contact can be provided as an asymmetrical relationship. In some examples, an asymmetrical relationship enables non-public digital content associated with the user to be inaccessible to the contact, while digital content associated with the contact to be accessible to the user. In some examples, the digital content associated with the contact and accessible to the user can include non-public content. In some examples, the digital content associated with the contact and accessible to the user can include public content. In some implementations, the social networking service can provide an asymmetrical relationship between the user and the contact such that the social networking service can selectively provide access to the digital content associated with the user and shared via the social networking service.

For purposes of illustration, implementations of the present disclosure are described within the context of an example social networking service. The example social networking service enables users to organize contacts into social groupings provided as social circles. It is appreciated, however, that implementations of the present disclosure can be used in other types of social networking services and are not limited to social networking services that include social circles.

In general, social circles are categories to which a user can assign contacts and better control the distribution and visibility of social networking items distributed using the social networking service. In some implementations, a social circle can be provided as a data set defining a collection of contacts that are associated with one another in a computer-implemented social networking service. Generally, a social circle can be described from the perspective of an individual that is the center of a particular collection of socially interconnected people, or from the aggregate perspective of a collection of socially interconnected people. A social circle can have narrowly defined boundaries (e.g., members of the social circle might be familiar with one another) and permission may be required for a member to join a social circle. A user of the social networking service can define a social circle. The social circle, as a data set defining a collection of contacts, may reflect real-life social connections and/or interactions of the user. In some implementations, a social circle can be defined by a user as a personal representation or grouping of a set of contacts, the contacts may be unaware of the social circle and/or unaware of other members of the social circle.

Through the creation and use of social circles, the user can organize and categorize social networking contacts into various different groupings that can be used to control the visibility and access those contacts have to the items of digital content, such as text, digital images, videos, audio files, hyperlinks (e.g., uniform resource indicators, URIs), and/or other appropriate digital content distributed by the user or associated with the user's social networking profile. As one example, the user can distribute an item including an update about a work-related nuance to only a “coworker” circle, and spare other contacts within the social networking service from seeing information that is irrelevant to them.

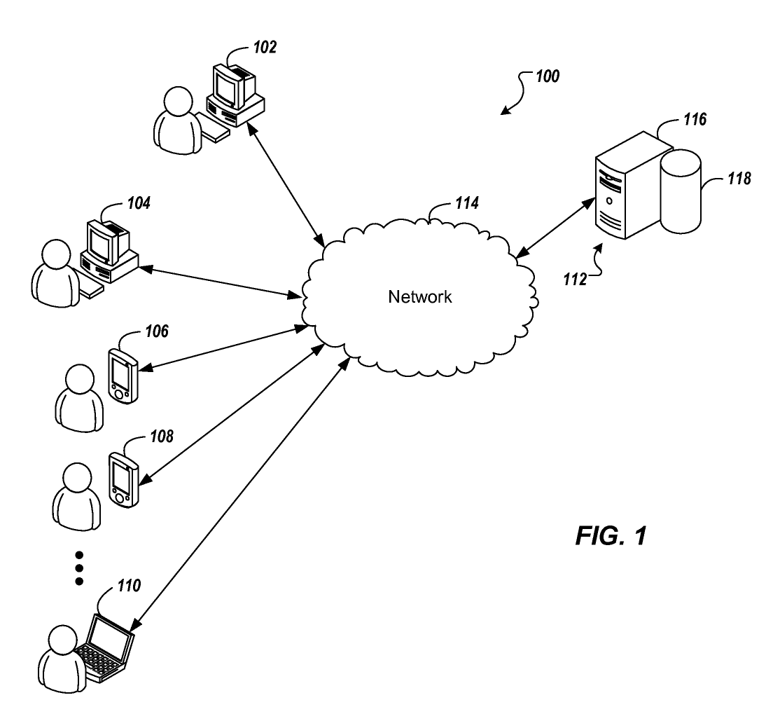

FIG. 1 is a diagram of an example network architecture 100. The network architecture 100 includes a number of client devices 102-110 communicably connected to a server system 112 by a network 114. The server system 112 includes a processing device 116 and a data store 118. The processing device 116 executes computer instructions stored in the data store 118, e.g., to perform the functions of a social network server.

Users of the client devices 102-110 access the server device 112 to participate in a social networking service. For example, the client devices 102-110 can execute web browser applications that can be used to access the social networking service. In another example, the client devices 102-110 can execute software applications that are specific to the social networking service (e.g., social networking “apps” running on smartphones).

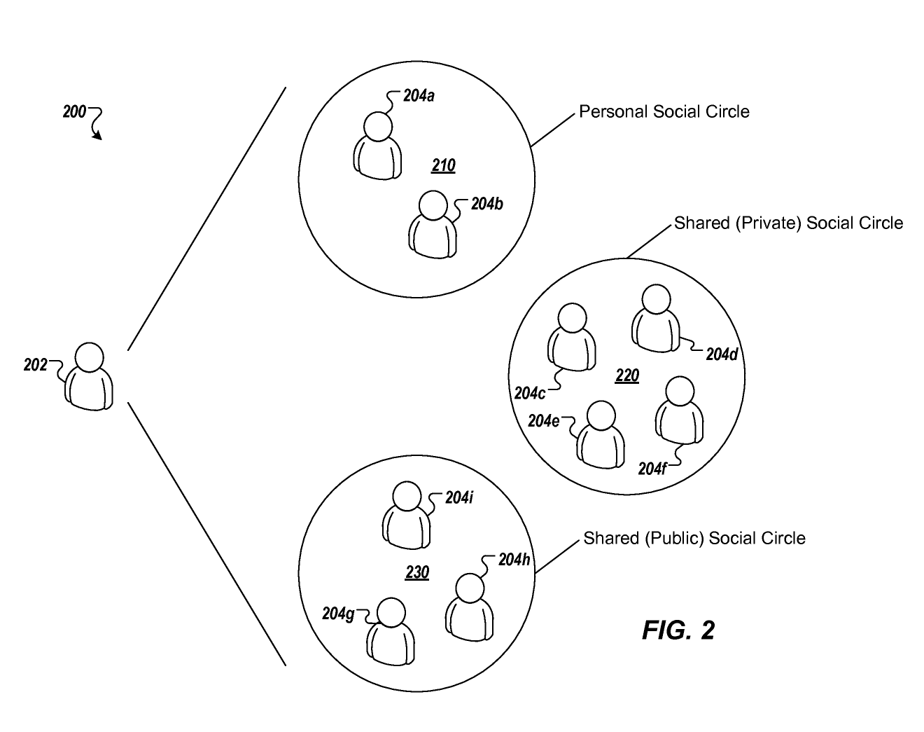

Users interacting with the client devices 102-110 can participate in the social networking service provided by the server system 112 by providing digital content, such as text comments (e.g., updates, announcements, replies), digital images, videos, audio files, and/or other appropriate digital content. In some implementations, information can be posted on a user's behalf by systems and/or services external to the social networking service or the server system 112. For example, the user distribute an item including a review of a movie to a movie review website, and with proper permissions that website can cross-post the review to the social networking service on the user's behalf. In another example, a software application executing on a mobile device, with proper permissions, can use global positioning system (GPS) capabilities to determine the user's location and automatically update the social network with his location (e.g., “At Home”, “At Work”, “In Brownsdale, Minn.”). Generally, users interacting with the client device 102-110 can also use the social networking service provided by the server system 112 to define social circles to organize and categorize the user's relationships to other users of the social networking service. Examples of the creation and use of social circles are provided in the description of FIG. 2.

In some implementations, the client devices 102-110 can be provided as computing devices such as laptop or desktop computers, smartphones, personal digital assistants, portable media players, tablet computers, or other appropriate computing devices that can be used to communicate with an electronic social network. In some implementations, the server system 112 can be a single computing device such as a computer server. In some implementations, the server system 112 can represent more than one computing device working together to perform the actions of a server computer (e.g., cloud computing). In some implementations, the network 114 can be a public communication network (e.g., the Internet, cellular data network, dialup modems over a telephone network) or a private communications network (e.g., private LAN, leased lines).

FIG. 2 is a diagram of an example social network 200 including social circles. A user 202 is a member of a social network that supports the creation and use of social circles (e.g., the social network provided by the server device 112 of FIG. 1). In the present example, the user 202 has a number of contacts 204a-204i with which the user 202 can have some form of relationship (e.g., friends, coworkers, customers, teammates, clients, relatives, club members, classmates). The user 202 categorizes the contacts 204a-204i by assigning them to one or more social circles, such as a social circle 210, a social circle 220, and a social circle 230.

The social circle 210 is a personal circle. In some implementations, personal circles are groupings created by and might be known only to the user 202 (e.g., the contacts 204a, 204b may receive no indication that they are in the user's 202 personal social circle 210). In some implementations, personal social circles are groupings created by the user 202 and may be known to the user 202 as well as the contacts (e.g., contacts 204a, 204b) that are members of the social circle (e.g., the contacts 204a, 204b receive an indication that they have been added to the personal social circle 210).

In some implementations, personal circles can be used to organize and categorize the contacts 204a-204i in ways that are relevant to the user 202. In some implementations, the user 202 may use personal social circles to organize contacts in order to discretely target which of his contacts 204a-204i will see certain items or have access to particular information. For example, the user 202 may be planning a surprise party for a small group of friends. As such, the user can organize contacts into “Surprise Party Attendees” and “Surprise Party Honorees” personal circles. By doing so, the user 202 may better target selected items to the friends attending and/or helping to plan the surprise party (e.g., Surprise Party Attendees), while targeting selected items to friends that are to be honored at the surprise party (e.g., Surprise Party Honorees) to maintain the integrity of the surprise.

The social circle 220 is a shared private circle, which may also be referred to simply as a shared circle. In general, shared private circles are social circles that the user 202 creates and invites contacts to voluntarily join. Contacts that accept the invitation become members of the shared private circle. Members of a shared private circle can see information posted to that circle by the user 202 and can distribute information to be shared with other members of the shared private circle. For example, the user 202 may tend to distribute a large number of jokes to the social network. However, while some of the contacts 204a-204i may find the jokes to be entertaining, others may find them to be simply annoying. Realizing this, the user 202 may create a “jokes” shared private circle and invite some or all of the contacts 204a-204i to join. With the “jokes” social circle in place, the user 202 may distribute witticisms to the “jokes” circle, and only those contacts who have accepted the invitation are able to see the comicality of the user 202. Similarly, members of the shared private circle are able to distribute messages to the circle, and those messages are visible to other members of that circle.

The social circle 230 is a shared public circle. In general, shared public circles are social circles that the user 202 creates, and invites contacts to voluntarily join. Further, the existence of a shared public circle is publicly available such that other users of the social networking service (e.g., not necessarily just the user's 202 contacts 204a-204i) may request to join the public social circle. Members of shared public circles may distribute information to, and see updates distributed by, other members of the same public shared circle. In some implementations, public shared circles may be “fan” or “group” circles (e.g., circles dedicated to a particular place, event, product, movie, celebrity, sports team, company, concept, philosophy, organization, support network). For example, the user 202 may create a shared public circle for his band, and fans of his act can join the circle to discuss upcoming shows, download MP3s of the band's music, or post videos from recent concerts. In another example, the user 202 can create a shared public circle for alumni of his high school graduating class, which his former classmates may find and join in order to stay in touch with one another and distribute pictures from their school days. Once a shared public circle is created, in some implementations, the user 202 can invite people to join the circle. In some implementations, nonmembers of the circle can request membership in the shared public circle, and membership in a shared public circle may be automatic upon request, or may require the user's 202 approval to become members of the shared public circle.

In some implementations, one or more default social circles can be provided or suggested to a user when the user subscribes to a social networking service. For example, “Friends,” “Family,” and “Coworkers” social circles can automatically be provided in a user's profile upon the user subscribing to the particular social networking service. Other social circles can automatically be provided including, for example, an “Acquaintances” social circle and/or a “Just Following” social circle. In some implementations, the automatically created or suggested social circles can include personal social circles. Although default social circles can be automatically provided, it can be left to the user to actually populate the default social circles with contacts. For example, each of the default social circles can initially be empty of contacts, and the user populates each of the default social circles as discussed in further detail herein.

In some examples, digital content can be distributed using the social networking service, such that it is publicly available to all users of the Internet. In some examples, digital content can be distributed to all users of the social networking service, such that it is accessible by any user of the social networking service. In some examples, digital content can be distributed to contacts within the social networking service including one or more social circles, such that they are exclusively viewable by the indicated contacts and/or contacts within one or more indicated social circles. For example, a user of the social networking service can generate an item including digital content and indicate one or more social circles for distribution of the item. In some implementations, an auto-complete component enables the user to type in part of the name of a social circle and/or individual contact to specify which social circles and/or individual contacts require delivery of the item content. During an item write-time, an item data set is transmitted from the user's client computing device (e.g., client device 102 of FIG. 1) to a distribution hub, which can be provided at a server (e.g., server system 112 of FIG. 1). In some implementations, the item data set includes item content data (e.g., text, uniform resource indicator (URI)), timestamp data (e.g., a timestamp indicating the time that the post was generated), distribution data (e.g., contacts and/or one or more social circles), and identification (ID) data (e.g., an ID assigned to the item data set upon generation of the item).

In some implementations, and as discussed in further detail herein, other data can be appended to item data sets. Example other data can be spam indication data and scoring data. In some examples, spam indication data can be appended to an item data set to indicate that the item data set is considered to be spam. In some examples, scoring data can include a social affinity score among other possible scoring data. In some examples, source indication data can be appended to the item data set to indicate the route through which the user distributed the item, as discussed in further detail herein. In some implementations, with the permission of a user, location data can be appended to item data sets. The location data can indicate the location from which an associated item was distributed. In some examples, the location data can be determined based on an explicit indication of location by the user (e.g., a check-in), wifi signal locating, GPS signal locating, cellular tower triangulation, IP address and/or any other appropriate technique for determining the location from which a user distributes an item to the social networking service.

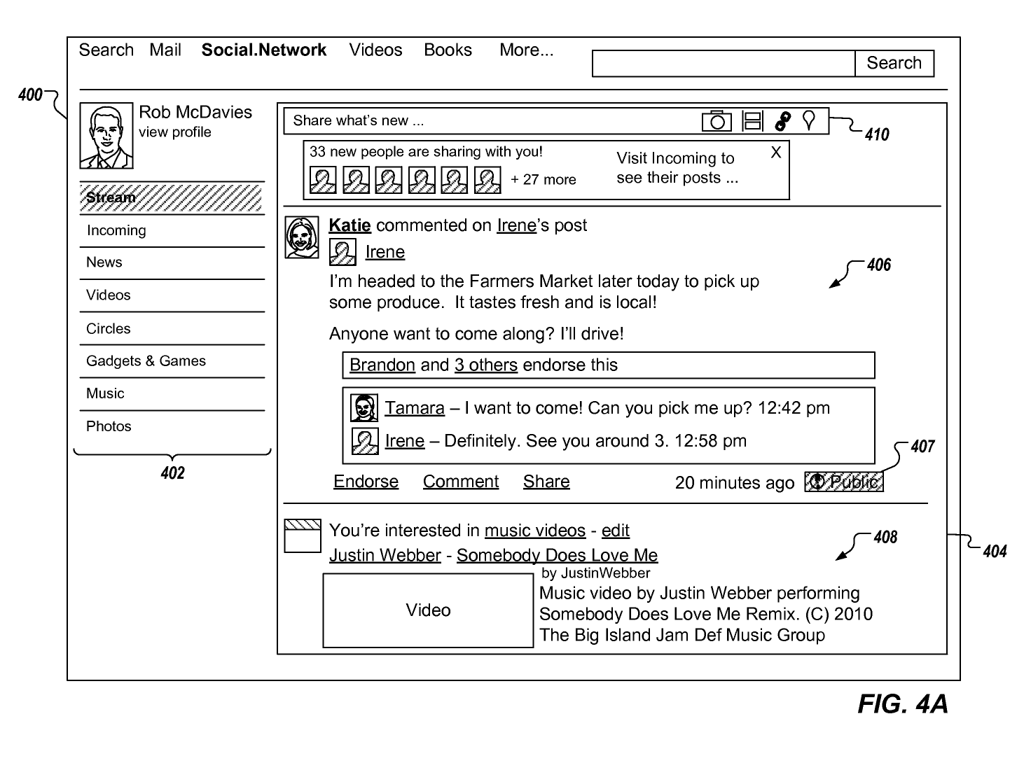

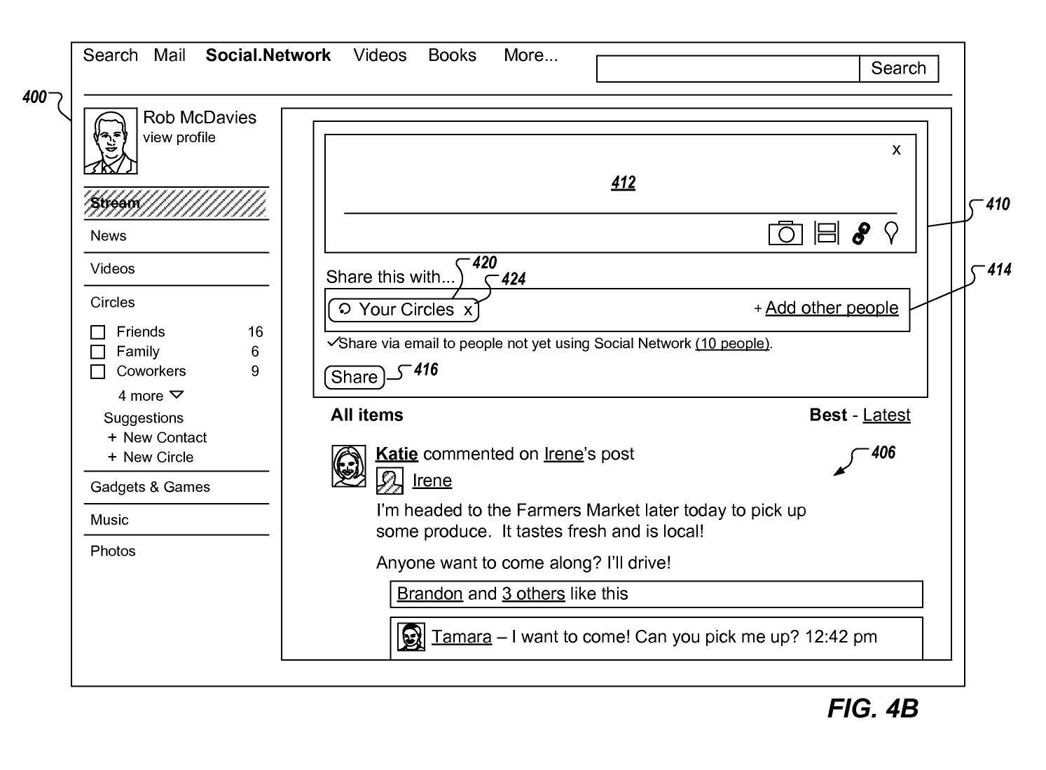

In some implementations, the distribution data is processed to provide an access control list (ACL) that specifies which users are granted access to the item content. In some examples, the users include users of the social networking service. In some examples, the users include users of the Internet. In some instances, the users include all users of the Internet, and an item can be displayed on a web page within a social networking service in association with an identification icon (to be described with respect to FIG. 4A) denoting the item as a publicly shared item.

Generally, the distribution hub determines end points the item data set is to be distributed to based on the ACL. More specifically, the set of contacts that may care about the item and/or that are allowed access to the item is determined based on the ACL, and the ID of the item is written to a per user/view index at the distribution hub. When fetching items to distribute to a user, the user/view index is accessed and the IDs of the various items that the user is allowed to view are determined. The item data sets are retrieved from a data store (e.g., data store 118 of FIG. 1) and are transmitted to a client device associated with the requesting user. In some implementations, and as discussed in further detail herein, the ACL can be provided based on the overall score, the quality score and/or the social affinity score.

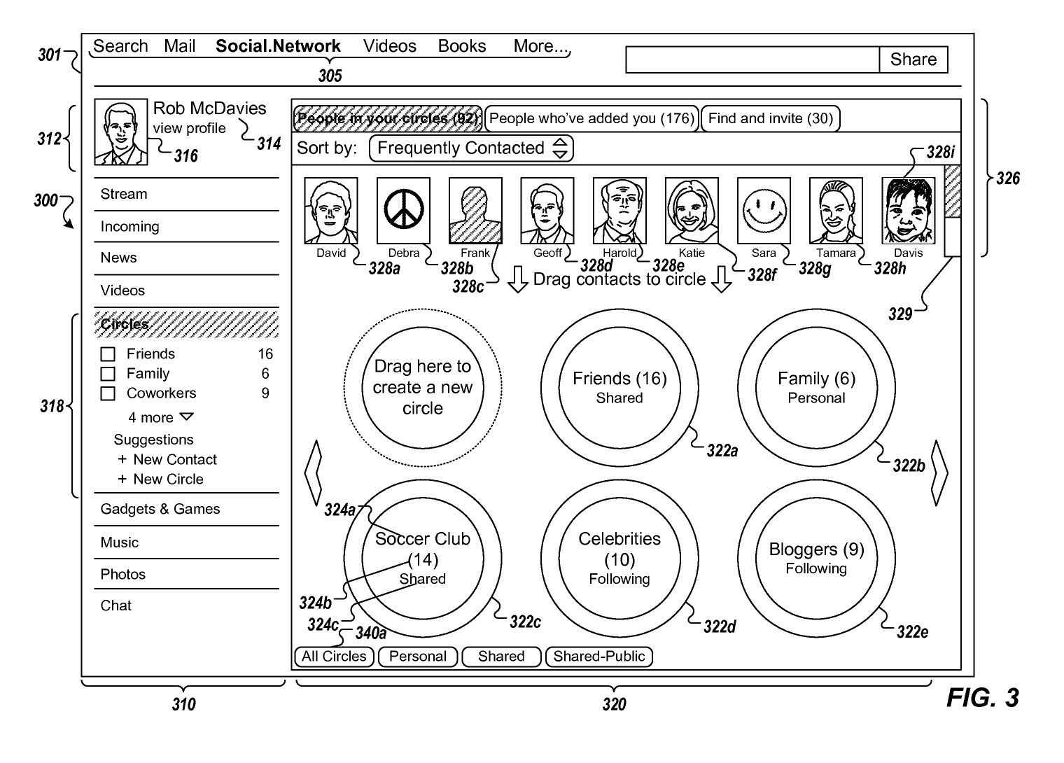

FIG. 3 depicts a screen-shot 300 of an example graphical user interface for creating and maintaining social circles. In the screen-shot 300, a social graph editor user interface (UI) 301 is shown. In some implementations, the UI 301 can be the interface presented by a purpose made social networking application, while in some implementations the UI 301 can be one or more web pages of a social networking website displayed in a general purpose web browser.

In the example of FIG. 3, the UI 301 includes a number of choices presented in a menu bar 305. In the present example, the “Social Network” choice has been selected by a user. This selection causes a web-based social networking application to be executed and a social network menu 310 to be displayed. The social network menu 310 includes a profile indicator 312 in which information such as a user name 314 and a user image 316 associated with the currently logged in user are displayed.

The social network menu 310 also displays, among other items, a social circles sub-menu 318. The social circles sub-menu 318, when selected (e.g., as represented by the highlighting of the submenu's title), causes a social circle display 320 to be presented. The social circle display 320 includes a number of circles 322a-322e that are visual representations of various social circles that the user has created or has permission to edit. Each of the circles 322a-322e displays information about the social circle it represents. For example, the circle 322c displays a name 324a, a count 324b of the number of contacts associated with the social circle, and an indication 324c of the type of circle 322c (e.g., personal, private shared, public shared).

The social circle display 320 also includes a contact display 326. The contact display 326 provides a graphical interface for viewing, selecting, and organizing items in the user's contact lists. A collection of contact icons 328a-328i represents the contacts or other entities (e.g., organizations, places, or other items) socially networked with the particular user. In some implementations, the icons can be digital photos of the contacts they represent (e.g., the icons 328a, 328d), arbitrary images (e.g., the icons 328b, 328g), or placeholders (e.g., when the contact has no image associated with their account, such as the icon 328c). In some implementations, the icons can include additional information, such as the names of each contact. A scroll bar 329 is provided for the user to view additional contact icons that may not fit into the initial view.

In accordance with implementations of the present disclosure, attributes of one or more social circles can be defined by the user to establish a type of relationship with members of each of the one or more circles. In the example of FIG. 3, circles 322d, 322e are provided as “following” circles indicating a particular type of asymmetrical relationship between the user and members of the circles 322d, 322e, as discussed in further detail below. In some implementations, following circles 322d, 322e can include members that are other users of the social networking service from which the user 202 can receive access to content (e.g., items), but with whom the user 202 does not share content. For example, the user 202 may wish to access or follow items distributed by particular celebrities, but may not wish to share non-public information with the celebrities. Accordingly, the user 202 can add the particular celebrities as members to a particular circle (e.g., the following circle 322d) that already has an attribute set that establishes the asymmetrical relationship with members of the particular circle. In some examples, the user can access public digital content distributed by the other users included within the following circle. In some examples, the user can access non-public digital content distributed by the other users within the following circle.

FIGS. 4A-4B depict a screenshot of an example stream page 400 for a user of a social networking service including an example content sharing interface. As shown in FIG. 4A, the stream page 400 includes an activity stream 404 for a user of a social networking service. For example, the web page 400 can be provided as a web page within a website of a social networking service and can display items of digital content that have been shared with a user associated with the web page 400. In the illustrated example, the example user includes “Rob McDavies,” and the web page 400 displays items of digital content that other users have shared with the user and/or items that the user has shared with other users. The web page 400 includes a social network menu 402 and the activity stream 404. As used herein, the term activity stream can include a graphically displayable collection of items that have been distributed to and/or from, or are otherwise accessible by a user of a social networking service. Example items 406, 408 that have been distributed to the user are displayed in the activity stream 404. Generally, the items 406, 408 displayed in the activity stream 404 include digital content that is distributed to the user from contacts established within the social networking service. In some implementations, an identification icon 407 can be displayed in association with an item (e.g., item 406 in this example) and characterizes a level of the item distribution. In the example of FIG. 4A, the item 406 has a public distribution level, indicating that all users of the internet can view the item 406. A content sharing interface 410 can also be provided. The user can activate (e.g., click on) the content sharing interface 410 to share digital content. Although two items 406, 408 are depicted in FIG. 4, it is appreciated that the activity stream 400 can display any number of items to the user.

FIG. 4B depicts another screen-shot of the example stream page 400. In the illustrated example, the user has clicked on the content sharing interface 410 and the content sharing interface 410 expands to include content input area 412, a distribution interface 414 and a share button 416. In the illustrated example, an example identifier icon 420 is provided in the distribution interface 414. As discussed above, the identifier icon 420 is provided as a visual representation of one or more users that digital content is to be shared with. In the example of FIG. 4B, a user has tentatively indicated that digital content within the content input area 412 is to be shared with members of all of the user's social circles, as denoted by the icon description “Your Circles”. Until the post is committed, the identifier icon 420 provides a tentative distribution for the digital content. For example, the user can activate (e.g., click on) a delete control 424 of the identifier icon 420 to remove the identifier icon 420 from the distribution interface 414.

In the example of FIG. 4B, a distribution for digital content provided in the content input area 412 can be defined by the social circles and/or contacts identified in the distribution interface 414. A distribution can be defined based on one or more identifier icons that are provided in to the distribution interface 414. In the depicted example, a distribution is defined by all social circles (graphically represented by the identifier icon 420) and includes all of the contacts that are members of all of the user's social circles, with the exception of contacts included within any following circles (e.g., following circles 322d, 322e), as discussed in further detail below.

In some implementations, and as introduced above, a relationship between a user and a contact can be a symmetrical relationship or an asymmetrical relationship. A symmetrical relationship can be provided when the contact is also a user of the social networking service and has added the user as a contact within the social networking service. For example, and with continued reference to FIG. 3, the user “Rob McDavies” can add the potential contact “David” to a social circle, thereby establishing “David” as an actual contact within the context of the social networking service. Independently, “David” can also be a user of the social networking service and can add “Rob McDavies” to a social circle, thereby establishing “Rob McDavies” as an actual contact within the context of the social networking service. In this manner, items shared by “Rob McDavies” using the social networking service can be displayed to “David” within the social networking service (e.g., on a stream page associated with “David”), and items shared by “David” using the social networking service can be displayed to “Rob McDavies” within the social networking service (e.g., on a stream page associated with “Rob McDavies”).

One type of asymmetrical relationship can be provided when the contact is not a user of the social networking service. For example, and with continued reference to FIG. 3, the user “Rob McDavies” can add the potential contact “Tamara” to a social circle, thereby establishing “Tamara” as an actual contact within the context of the social networking service. In this example, however, “Tamara” is not a user of the social networking service, and is instead a contact of “Rob McDavies” via another service (e.g., a contact via an electronic messaging service). In this manner, items shared by “Rob McDavies” using the social networking service can be conveyed to “Tamara” outside of the social networking service (e.g., via an electronic message).

In some examples, another type of asymmetrical relationship can be provided when the contact is a user of the social networking service, but does not include the user as a contact. For example, and with continued reference to FIG. 3, the user “Rob McDavies” can add the potential contact “Geoff” to a social circle, thereby establishing “Geoff” as an actual contact within the context of the social networking service. In this example, however, “Geoff” is a user of the social networking service, but has not added the user “Rob McDavies” as an actual contact within the social networking service. In this manner, items shared by “Rob McDavies” using the social networking service can be distributed via the social networking service to “Geoff,” but items shared by “Geoff” using the social networking service may not be distributed via the social networking service to “Rob McDavies.”

Implementations of the present disclosure are directed to defining one or more attributes associated with a particular social circle. In some implementations, an attribute can define a sharing relationship between a user and one or more contacts that are members of the particular social circle. In some examples, the relationship between the user and the contact can be provided as a symmetrical relationship, whereby non-public digital content associated with the user is accessible to the contact, and conversely, non-public digital contented associated with the contact is accessible to the user. In some examples, the relationship between the user and the contact can be provided as an asymmetrical relationship, whereby non-public digital content associated with the user is inaccessible to the contact, and digital content associated with the contact is accessible to the user. In some instances, the digital content that is associated with the contact and that is accessible to the user is non-public content. In some instances, the digital content that is associated with the contact and that is accessible to the user is public content. In some implementations, an attribute can be explicitly defined or implicitly defined.

In some implementations, a sharing relationship attribute of a first social circle can be set to provide an asymmetrical relationship between the user that defined the first social circle and a contact that is a member of the first social circle. In some examples, the sharing relationship attribute can be set to designate the first social circle as a following circle (e.g., the circle 322d, 322e). In some examples, the contact can add the user to a second social circle defined by the contact. Regardless of whether the contact has added the user to the second social circle, items can be prevented from being distributed to the contact by designating the first social circle as a following circle. In some implementations, however, contacts within a following circle are able to access items distributed publicly to all Internet users (e.g., the item 406 denoted by the identification icon 407) and other public content associated with the user. As discussed in further detail herein, a social circle can be designated as a following circle explicitly or implicitly.

In some implementations, other data that is provided by the user through the social networking service can be access controlled relative to a contact based on whether the contact is a member of a following social circle. In some examples, the user can provide information (e.g., full name, address, employment information, hobbies, educational information, etc.) on a profile page associated with the user in the social networking service. In some examples, the profile page is protected from access by contacts that are members of a following circle. In some examples, the profile page can be accessed by contacts that are members of a following circle, but particular information (e.g., home address, telephone number) can be protected from access by such contacts.

In some implementations, contacts within a following circle can be excluded from an item distribution that is designated for all contacts within all social circles (e.g., as indicated by the identifier icon 420 denoted as “Your Circles”) of a user. For example, the item distributed via the content sharing interface 410 in FIG. 4B can be distributed to all social circles of “Rob McDavies” (e.g., circles 322a-322c), with the exception of following circles 322d, 322e.

In some examples, a set operation can be performed to exclude following circles from distribution of an item. An example set operation can include an “ALL EXCEPT” set operation indicating all sets except one or more particular sets are to be used to define the distribution. In this context, a social circle defines a set. In cases where the distribution is defined to include all social circles (e.g., the identifier icon 420 denoted as “Your Circles” is used to define the distribution), the actual distribution can be defined using the ALL EXCEPT operation and can include all of the users social circles except social circles that are designated as following circles. By way of non-limiting example, a user can have defined social circles A, B, C, D, with the social circle D having been designated a following circle. The user can distribute an item of digital content to all social circles (e.g., by designating a “Your Circles” identifier icon in a distribution interface associated with the item). In response, an ALL EXCEPT set operation can be performed to define the distribution as including social circles A, B, C and excluding social circle D. Consequently, members of the social circles A, B, C can access the item of digital content, while members of social circle D are prevented access to the item of digital content.

In some implementations, a user can explicitly designate any social circle (e.g., a personal, shared, or shared-public social circle) as a following circle by setting one or more attributes associated with the social circle. In some examples, a contact may be a member of both a following circle and a social circle that is not designated as a following circle. In some examples, the social networking service can apply the least restrictive distribution preference (e.g., the contact being a member of a circle that is not designated as a following circle) such that the contact can receive items shared via the social networking service by the user. In some instances, the social networking service can apply the most restrictive distribution preference (e.g., the contact being a member of a following circle) such that the contact does not receive items shared via the social networking service by the user.

In some implementations, the social networking service may provide other attributes for characterizing a sharing relationship. In some examples, and as discussed above, a sharing relationship attribute can be set for a social circle to define a sharing relationship between the user and members of the social circle. In some implementations, an attribute associated with a particular social circle can impose an analytical constraint (e.g., a quantitative constraint) on the items that are shared by a user with contacts included within the particular social circle. In some examples, items shared by and/or to the user can be limited to items having a file size within a particular range. In some examples, items shared by and/or to the user can be limited to a particular number of items in a given time period (e.g., as characterized by an item frequency). Items may further be shared based on other analytical constraints. In some examples, items shared by and/or to the user can be limited to particular types of items (e.g., text, video, images, links). In some examples, items shared to the user can be limited based on an audience that is to receive items. For example, it can be determined whether other users that an item was shared to have any social affinity to the user. If there is no social affinity, the item is not shared to the user. If there is social affinity, or at least a sufficient degree of social affinity, the item is shared to the user.

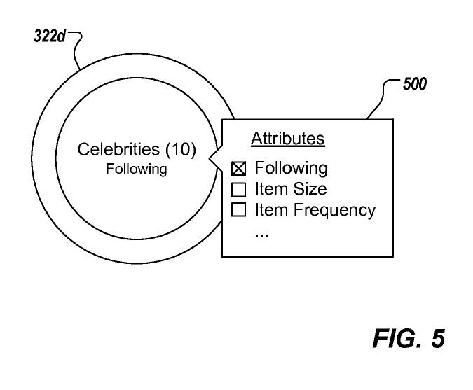

FIG. 5 depicts an example interface 500 for defining one or more attributes associated with a particular social circle. In some implementations, the example interface 500 can be displayed in association with a social circle when a user right-clicks on the social circle as displayed within a social graph editor UI (e.g., the UI 301) and/or hovers an input indicator (e.g., a mouse, cursor) over the social circle. In some examples, an attribute, such as a “Following” attribute can characterize a sharing relationship. In some implementations, selecting the “Following” attribute (as indicated by an x within a toggle box) explicitly designates a social circle as a following circle. Consequently, a sharing relationship between the user and contacts of the social circle can be provided as in asymmetrical relationship, where the contacts have limited access to data provided by the user. In some examples, an attribute, such as an “Item Size” attribute or an “Item Frequency” attribute can impose an analytical constraint on items shared by a user with contacts included within the particular social circle. In some examples, analytical constraint can be imposed on items shared by contacts included within the particular social circle with the user. In some implementations, selecting an attribute associated with an analytical constraint can cause a menu (not shown in FIG. 5) to be displayed in association with the attribute that allows the user to provide a numerical value associated with the attribute. For example, upon selecting the “Item Frequency” attribute, a user may enter a value of “3” within the menu, designating that up to three posts can be distributed to contacts within the particular social circle per time period (e.g., per day).

It is appreciated that other interfaces can be provided to enable a user to designate a social circle as a following circle. For example, an interface can be provided for original creation of a social circle, which interface can include an option for designating the to be created social circle as a following circle.

In some implementations, designation of a social circle as a following circle can be determined implicitly. In some examples, information associated with a social circle can imply whether the social circle could be designated as a following circle. Example information can include a name of the social circle, a number of members populating the social circle, a number of pages that populate the social circle and/or whether the social circle originated as a suggested social circle. In some examples, one or more pieces of information can be considered to implicitly determine whether a social circle is to be designated as a following circle. In some implementations, a user's interaction with the social circle and/or social affinities between the user and members of the social circle can provide implicit signals that can be used to imply whether the social circle could be designated as a following circle. For example, if the user never or rarely shares items to the social circle and has limited social affinity with the members of the social circle, it can be implied that the social circle can be designated as a following circle.

In some examples, a name and/or words within the name of the social circle can be compared to a list of representative names, where each representative name is associated with social circles that are typically designated as following circles. In some examples, if the name, words in the name and/or translations of the name and/or words in the name of the social circle at least partially matches a representative name provided in the list of representative names, it can be implied that the social circle should be designated as a following circle. By way of non-limiting example, a user can create a social circle with the name “Celebrities” and/or the word “celebrities” otherwise provided in the name. “Celebrities” can be compared to a list of representative names. In some examples, “Celebrities” is provided in the list of representative names. Consequently, an indication can be made that the social circle should be designated as a following circle.

In some examples, the number of members provided in the social circle can be compared to a threshold number of members and, if the number of members is greater than the threshold number of members, it can be implied that the social circle should be designated as a following circle. Consequently, an indication can be made that the social circle should be designated as a following circle.

In some examples, the number of pages that are provided in the social circle can be compared to a threshold number of pages. In some implementations, the social networking service can provide so-called “pages” that enable participation of an entity with the social networking service. Example entities can include companies, clubs, societies, institutions (e.g., colleges, universities), professional associations, lay associations and the like. A page provides an entity representation within the social networking service and enables the entity to interact with other users (e.g., persons and/or entities) of the social networking service. In some examples, if the number of pages that are provided in the social circle is greater than the threshold number of pages, it can be implied that the social circle should be designated as a following circle. Consequently, an indication can be made that the social circle should be designated as a following circle.

In some examples, the social circle can be provided as a suggested social circle. For example, the social networking service and/or users of the social networking service can suggest one or more social circles to a user. In some examples, a user can adopt a suggested social circle. Consequently, an indication can be made that the social circle should be designated as a following circle. By way of non-limiting example, a suggested social circle can include “Celebrities” that includes members that are determined (e.g., by themselves and/or other users) to be a celebrities. If a user adopts the suggested social circle an indication can be made that the social circle should be designated as a following circle.

In some implementations, if a social circle is implicitly identified as being a potential following circle, the social circle can automatically be designated as a following circle. In some implementations, if a social circle is implicitly identified as being a potential following circle, the user can be prompted to designate the social circle as a following circle. For example, a notification can be displayed to the user and can suggest to the user that the social circle be designated as a following circle.

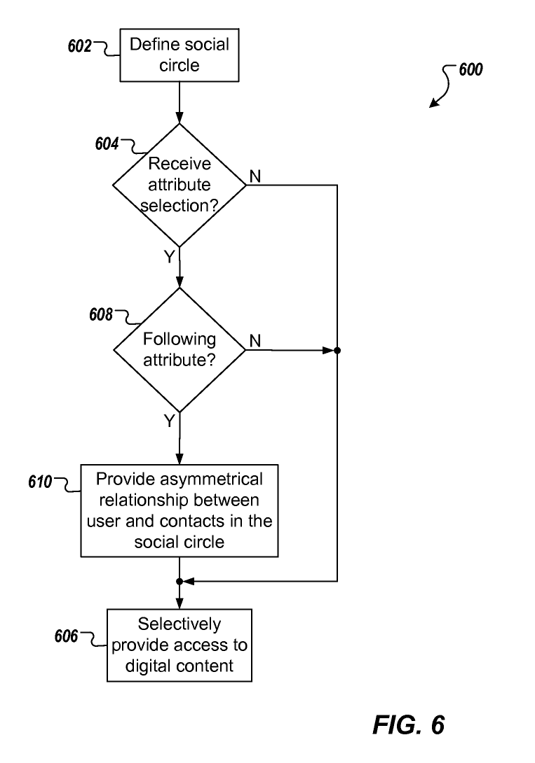

FIG. 6 is a flowchart of an example process 600 that can be executed in implementations of the present disclosure. In some implementations, the example process 600 can include operations that are performed using one or more computer programs executed using one or more data processing apparatus (e.g., one or more client-side computing devices and/or one or more server-side computing devices). The example process 600 can be executed to selectively provide access to digital content provided by a user of a social networking service.

A social circle is defined (602). For example, the social circle can be defined based on input provided by a user of a social networking circle. The social circle includes one or more contacts that are users of the social networking service. It is determined whether an attribute selection has been set for the social circle (604). If an attribute selection has not been received, selective access to digital content can be provided based on the social circle (608). If an attribute selection has been received (e.g., explicitly, implicitly), it can be determined whether the attribute includes a following attribute (608). If the attribute does not include the following attribute, selective access to digital content can be provided based on the social circle (608). If the attribute includes the following attribute, an asymmetrical relationship between the user and the one or more contacts included within the social circle can be provided (610). Based on the asymmetrical relationship, the social networking service can selectively provide access to digital content provided by the user to contacts networked with the user within the social networking but excluding the one or more contacts included within the social circle, as discussed above.

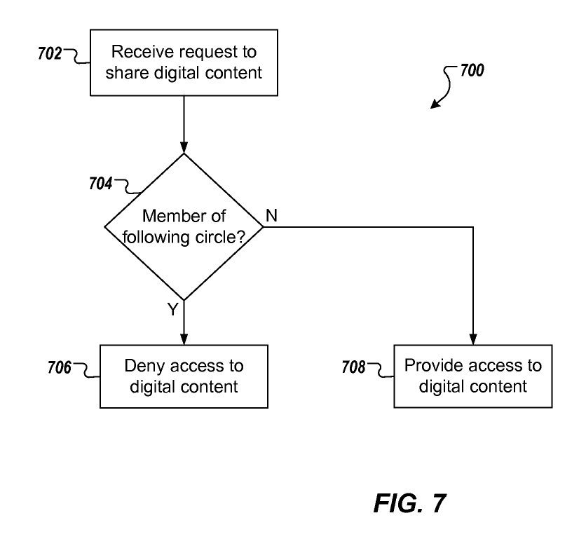

FIG. 7 is a flowchart of an example process 700 that can be executed in implementations of the present disclosure. In some implementations, the example process 700 can include operations that are performed using one or more computer programs executed using one or more data processing apparatus (e.g., one or more client-side computing devices and/or one or more server-side computing devices). The example process 700 can be executed to selectively enable access to digital content distributed within a social networking service.

A request to access digital content can be received (702). For example, a contact included within a social circle defined by a user can request access to digital content provided by the user within a social networking service (e.g., can click on a profile page of the user). It is determined whether the contact is a member of social circle that is designated as a following circle (704). If the contact is a member of a following circle, the contact is denied access to the requested digital content (706). If the contact is not a member of a following circle, the contact is provided access to the digital content (708).

In some implementations, if the contact is a member of both a following circle and a social circle that is not designated as a following circle, then the social networking service can apply a least restrictive access preference and provide the contact with access to the digital content. In some implementations, if the contact is a member of both a following circle and a social circle that is not designated as a following circle, then the social networking service can apply a most restrictive distribution preference and deny the contact access to the digital content.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Implementations of the present disclosure and all of the functional operations provided herein can be realized in digital electronic circuitry, or in computer software, firmware, or hardware, including the structures disclosed in this specification and their structural equivalents, or in combinations of one or more of them. Implementations of the invention can be realized as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclose can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the invention can be realized in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this disclosure contains many specifics, these should not be construed as limitations on the scope of the disclosure or of what may be claimed, but rather as descriptions of features specific to particular implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the present disclosure have been described. Other implementation s are within the scope of the following claims. For example, the actions recited in the claims can be performed in a different order and still achieve desirable results.

What is claimed is:

1. A computer-implemented method executed by a computing system that provides a social networking service, the method comprising:
defining, by the computing system and based on input provided by a user of the social networking service, a plurality of groups of contacts of the user, wherein each group of contacts represents a respective set of one or more other users of the social networking service, wherein the plurality of groups of contacts includes a first group of contacts that represents a first set of multiple other users of the social networking service;
receiving, by the computing system, a request to assign a first attribute to the first group of contacts, and in response, assigning the first attribute to the first group of contacts, wherein the first attribute specifies that non-public digital content distributed by the user is inaccessible to the first set of multiple other users of the social networking service represented by the first group of contacts;
defining, by the computing system and based on input provided by the user of the social networking service, an initial distribution group associated with a first non-public digital content item that is to be distributed using the social networking service, the initial distribution group comprising particular selected ones of the plurality of groups of contacts of the user;
receiving, by the computing system, a command input from the user requesting the computing system to distribute the non-public digital content item to the distribution group; and
in response to (i) receiving the command input and (ii) determining that the first attribute is assigned to the first group of contacts:
determining that a subset of contacts in the initial distribution group are also in the first group of contacts;
generating a revised distribution group by removing the subset of contacts from the initial distribution group; and
distributing the non-public digital content item to contacts in the revised distribution group, but not to the subset of contacts that are also in the first group of contacts.

2. The method of claim 1, further comprising distributing, by the computing system, public digital content items from one or more contacts in the first group of contacts to the user.

3-6. (canceled)

7. The method of claim 6, further comprising providing, by the computing system, access to the first non-public digital content item distributed by the user to contacts networked with the user within the social networking service and excluding contacts in the first group of contacts.

8. A system comprising:
one or more computers configured to perform operations comprising:
defining, based on input provided by a user of a social networking service, a plurality of groups of contacts of the user, wherein each group of contacts represents a respective set of one or more other users of the social networking service, wherein the plurality of groups of contacts includes a first group of contacts that represents a first set of multiple other users of the social networking service;
receiving a request to assign a first attribute to the first group of contacts, and in response, assigning the first attribute to the first group of contacts, wherein the first attribute specifies that non-public digital content distributed by the user is inaccessible to the first set of multiple other users of the social networking service represented by the first group of contacts;
defining, based on input provided by the user of the social networking service, an initial distribution group associated with a first non-public digital content item that is to be distributed using the social networking service, the initial distribution group comprising particular selected ones of the plurality of groups of contacts of the user;
receiving a command input from the user requesting the social networking service to distribute the non-public digital content item to the distribution group; and
in response to (i) receiving the command input and (ii) determining that the first attribute is assigned to the first group of contacts:
determining that a subset of contacts in the initial distribution group are also in the first group of contacts;
generating a revised distribution group by removing the subset of contacts from the initial distribution group; and
distributing the non-public digital content item to contacts in the revised distribution group, but not to the subset of contacts that are also in the first group of contacts.

9. The system of claim 8, wherein the operations comprise distributing public digital content items from one or more contacts in the first group of contacts to the user.

10-13. (canceled)

14. The system of claim 13, wherein the operations further comprise providing access to the first non-public digital content item distributed by the user to contacts networked with the user within the social networking service and excluding contacts in the first group of contacts.

15. A non-transitory computer-readable medium storing instructions that, when executed by one or more processors, cause the one or more processors to perform operations comprising:
defining, based on input provided by a user of a social networking service, a plurality of groups of contacts of the user, wherein each group of contacts represents a respective set of one or more other users of the social networking service, wherein the plurality of groups of contacts includes a first group of contacts that represents a first set of multiple other users of the social networking service;
receiving a request to assign a first attribute to the first group of contacts, and in response, assigning the first attribute to the first group of contacts, wherein the first attribute specifies that non-public digital content distributed by the user is inaccessible to the first set of multiple other users of the social networking service represented by the first group of contacts;
defining, based on input provided by the user of the social networking service, an initial distribution group associated with a first non-public digital content item that is to be distributed using the social networking service, the initial distribution group comprising particular selected ones of the plurality of groups of contacts of the user;
receiving a command input from the user requesting the social networking service to distribute the non-public digital content item to the distribution group; and
in response to (i) receiving the command input and (ii) determining that the first attribute is assigned to the first group of contacts:
determining that a subset of contacts in the initial distribution group are also in the first group of contacts;
generating a revised distribution group by removing the subset of contacts from the initial distribution group; and
distributing the non-public digital content item to contacts in the revised distribution group, but not to the subset of contacts that are also in the first group of contacts.

16. The computer-readable medium of claim 15, wherein the operations comprise distributing public digital content items from one or more contacts in the first group of contacts to the user.

17-20. (canceled)

21. The method of claim 1, further comprising:
receiving a second request to assign ea second attribute to a second group of contacts among the plurality of groups of contacts of the user, and in response, assigning the second attribute to the second group of contacts, wherein the second attribute specifies an analytical constraint that applies to digital content distributed by the user to contacts in the second group of contacts;
determining that the second group of contacts is included in the initial distribution group and that the first non-public digital content item exceeds the analytical constraint;
in response to determining that the second group of contacts is included in the initial distribution group:
generating the revised distribution group further by removing contacts in the second group of contacts from the initial distribution group; and
distributing the non-public digital content item to the contacts in the revised distribution group, but not to the contacts in the second group of contacts.

22. The method of claim 21, wherein the analytical constraint constrains distribution of the first non-public digital content item to contacts in the second group of contacts based on one of a characteristic of the first non-public digital content item and a sharing history.

23. The method of claim 6, further comprising:
receiving, by the computing system and from a first contact in the first group of contacts, a request to access non-public digital content items distributed by the user;
receiving, by the computing system, input from the user accepting the request from the first contact; and
in response to receiving the input from the user accepting the request from the first contact, granting access to the first contact to the non-public digital content items distributed by the user.

24. The system of claim 8, wherein the operations further comprise:
receiving a second request to assign a second attribute to a second group of contacts among the plurality of groups of contacts of the user, and in response, assigning the second attribute to the second group of contacts, wherein the second attribute specifies an analytical constraint that applies to digital content distributed by the user to contacts in the second group of contacts;
determining that the second group of contacts is included in the initial distribution group and that the first non-public digital content item exceeds the analytical constraint;
in response to determining that the second group of contacts is included in the initial distribution group:
generating the revised distribution group further by removing contacts in the second group of contacts from the initial distribution group; and
distributing the non-public digital content item to the contacts in the revised distribution group, but not to the contacts in the second group of contacts.

25. The system of claim 24, wherein the analytical constraint constrains distribution of the first non-public digital content item to contacts in the second group of contacts based on one of a characteristic of the first non-public digital content item and a sharing history.

26. The system of claim 13, wherein the operations further comprise:
receiving, from a first contact in the first group of contacts, a request to access non-public digital content items distributed by the user;
receiving input from the user accepting the request from the first contact; and
in response to receiving the input from the user accepting the request from the first contact, granting access to the first contact to the non-public digital content items distributed by the user.

27. The computer-readable medium of claim 15, wherein the operations further comprise:
receiving a second request to assign a second attribute to a second group of contacts among the plurality of groups of contacts of the user, and in response, assigning the second attribute to the second group of contacts, wherein the second attribute specifies an analytical constraint that applies to digital content distributed by the user to contacts in the second group of contacts;
determining that the second group of contacts is included in the initial distribution group and that the first non-public digital content item exceeds the analytical constraint;
in response to determining that the second group of contacts is included in the initial distribution group:
generating the revised distribution group further by removing contacts in the second group of contacts from the initial distribution group; and
distributing the non-public digital content item to the contacts in the revised distribution group, but not to the contacts in the second group of contacts.
